(19) United States
(12) Patent Application Publication
(10) Pub. No.: US 2026/0166600 A1
(43) Pub. Date: Jun. 18, 2026

(54) Method and System for Cleaning Reactor

(71) Applicant: LG Chem, Ltd., Seoul (KR)

(72) Inventors: Moon Sub Hwang, Daejeon (KR); Jeong Seok Lee, Daejeon (KR); Geun Tae Pak, Daejeon (KR)

(73) Assignee: LG Chem, Ltd., Seoul (KR)

(21) Appl. No.: 19/120,631

(22) PCT Filed: Jul. 4, 2024
(86) PCT No.: PCT/KR2024/009461

§ 371 Date: Apr. 11, 2025

(30) Foreign Application Priority Data
Dec. 5, 2023 (KR) 10-2023-0174487
Jul. 1, 2024 (KR) 10-2024-0086163

(51) Int. Cl. B08B 9/032; C11D 7/50

(52) U.S. Cl. CPC B08B 9/0325; C11D 7/5027; B08B 2203/007

(57) ABSTRACT

A method for cleaning a reactor may effectively and quickly clean fouling polymers in a reactor and a surrounding device by operating one or more heating devices, and prevent pipe plugging caused by the polymers that are molten in a cleaning solvent and transported after the cleaning. The method for cleaning a reactor may be performed by a system for cleaning a reactor.

### CROSS-REFERENCE TO RELATED APPLICATIONS

This application is a national stage entry under 35 U.S.C. § 371 of International Application No. PCT/KR2024/009461 filed on Jul. 4, 2024, which claims priority to Korean Patent Application No. 10-2023-0174487 filed on Dec. 5, 2023, and Korean Patent Application No. 10-2024-0086163 filed on Jul. 1, 2024 the disclosures of each of which are incorporated herein by reference in their entireties.

### TECHNICAL FIELD

The present disclosure relates to method and system for cleaning a reactor, and more particularly, to cleaning method and system that may effectively and quickly clean fouling polymers in a reactor and a surrounding device, and prevent pipe plugging caused by the polymers that are molten in a cleaning solvent and transported after the cleaning.

### BACKGROUND

Alpha-olefin is widely used commercially as an important material used in a comonomer, a detergent, a lubricant, a plasticizer, or the like. In particular, 1-hexene and 1-octene are widely used as the comonomers to control the density of polyethylene when producing linear low density polyethylene (LLDPE).

Linear alpha olefin such as 1-hexene or 1-octene is typically produced through an oligomerization reaction of ethylene. The oligomerization reaction of ethylene may be performed by the oligomerization reaction (trimerization reaction or tetramerization reaction) of ethylene in the presence of a catalyst using ethylene as a reactant. As a reaction product produced through the above reaction, not only a multi-component hydrocarbon mixture including the desired 1-hexene and 1-octene, but also a polymer may be produced as a by-product during a catalytic reaction. The polymer may float in a liquid reaction medium within the reactor, and be accumulated to a certain thickness in the reactor over time due to a fouling phenomenon caused by the accumulation of polymers. It is thus necessary to shut down an operation of the reactor and clean the reactor and its surrounding device.

In more detail, the polymers produced as a side reaction of the oligomerization reaction may foul in the reactor and its surrounding device, and remain for a long time. There is a need for chemical cleaning work such as hot flushing to remove the polymers. However, even when normally performing the cleaning work, a long cleaning time may be required due to a property of the fouling polymer. In addition, the device may not be completely cleaned using a conventional technique. If the device is not completely cleaned in this way, it may be difficult to proceed with a normal process even after the cleaning.

For example, as shown in FIG. 1, the cleaning may generally proceed in the following manner: a cleaning solution is preheated by a heat exchanger 230, and then supplied to a reactor 100, which is a device to be cleaned, to thus melt the fouling polymer in the reactor in the high-temperature cleaning solution, and then discharging the polymer-molten cleaning solution outward from the device. Here, due to external heat loss or the like, the cleaning solution, in which the polymer is molten, may have a temperature of a certain temperature or below in a transportation pipe. In this case, adhesion of the polymer may cause a problem such as plugging that the polymer clogs the transportation pipe or valve. Accordingly, there is a need to improve such a problem.

### SUMMARY

### Technical Problem

In order to solve the problems mentioned in the Background, an object of the present disclosure is to provide method and system for effectively cleaning a reactor, a pipe, and a surrounding device, fouled by polymers produced during a reaction.

Another object of the present disclosure is to provide method and system for cleaning a reactor that may prevent plugging from occurring in a transportation pipe in a cleaning process, and remove fouling polymers in a device in a short period of time with improved cleaning efficiency.

However, technical tasks of the present disclosure are not limited to those mentioned above, and other tasks not mentioned here may be obviously understood by those skilled in the art from the following description.

### Technical Solution

In one general aspect, the present disclosure provides a method for cleaning a reactor including: partially filling the reactor with a cleaning solvent by supplying the cleaning solvent from a cleaning solvent supply unit to the reactor through a cleaning solvent supply line; heating the cleaning solvent in the reactor; and filling the reactor with the cleaning solvent by additionally supplying the cleaning solvent from the cleaning solvent supply unit to the reactor through the cleaning solvent supply line, and transporting a cleaning solvent stream including polymers to the cleaning solvent supply unit through a cleaning solvent discharge line connected to an upper part of the reactor.

In the heating of the cleaning solvent in the reactor, a lower discharge stream of the reactor may be supplied to one or more heating devices, and refluxed to a side of the reactor.

In another general aspect, the present disclosure provides a system for cleaning a reactor including: a cleaning solvent supply unit receiving, storing, and preheating a cleaning solvent supplied from the outside, supplying the cleaning solvent by being connected to one or more of the lower part or side of the reactor through a cleaning solvent supply line, and recovering the cleaning solvent discharged from the reactor by being connected to an upper part of the reactor through a cleaning solvent discharge line; and a first heating device heating the cleaning solvent in the reactor using a steam as a heat source by being connected to one side of the reactor through a first heating circulation line.

An auxiliary circulation line may connect the cleaning solvent supply line and the cleaning solvent discharge line to each other, and the auxiliary circulation line may have one side connected between a valve disposed on the cleaning solvent supply line and the cleaning solvent supply unit, and the other side connected between a valve disposed on the cleaning solvent discharge line and the cleaning solvent supply unit.

### Advantageous Effects

The method and system for cleaning a reactor according to an aspect of the present disclosure may effectively clean the reactor, the pipe, and the surrounding device, fouled by the polymers produced during the reaction.

In addition, the method and system for cleaning a reactor according to the present disclosure may prevent the plugging from occurring in the transportation pipe in the cleaning process, and remove the fouling polymers in the device in the short period of time with the improved cleaning efficiency.

In more detail, the method and system for cleaning a reactor according to the present disclosure may effectively remove the fouling polymers on the inner wall of the reactor by operating one or more heating devices to thus prevent the turbulence and the heat loss occurring from the reactor when the cleaning solvent is circulated.

Advantageous effects of the present disclosure are not limited to those mentioned above, and other effects not mentioned here may be obviously understood by those skilled in the art from the description provided below.

### BRIEF DESCRIPTION OF THE DRAWINGS

FIG. 1 is a process flow diagram of a conventional method for cleaning a reactor.

FIG. 2 is a process flow diagram of a method for cleaning a reactor according to an aspect of the present disclosure.

FIG. 3A is a process flow diagram of the method for cleaning a reactor according to an aspect of the present disclosure, and shows a process of partially filling the reactor with a cleaning solvent.

FIG. 3B is a process flow diagram of the method for cleaning a reactor according to an aspect of the present disclosure, and shows a process of heating the cleaning solvent in the reactor.

FIG. 3C is a process flow diagram of the method for cleaning a reactor according to an aspect of the present disclosure, and shows a process of circulating a cleaning solvent stream by additionally supplying the cleaning solvent to the reactor.

FIG. 4A is a process flow diagram of the method for cleaning a reactor according to an aspect of the present disclosure, and shows a process of partially filling the reactor with the cleaning solvent.

FIG. 4B is a process flow diagram of the method for cleaning a reactor according to an aspect of the present disclosure, and shows a process of heating the cleaning solvent in the reactor.

FIG. 4C is a process flow diagram of the method for cleaning a reactor according to an aspect of the present disclosure, and shows a process of circulating the cleaning solvent stream by additionally supplying the cleaning solvent to the reactor.

### DETAILED DESCRIPTION

Terms and words used in the descriptions and claims of the present disclosure are not to be construed as a general or dictionary meaning but are to be construed as meaning and concepts meeting the idea of the present disclosure based on a principle that the inventors may appropriately define the concepts of terms in order to describe their own inventions in the best mode.

Throughout the accompanying drawings, similar components are denoted by similar reference numerals.

A singular noun corresponding to an item is intended to include one or more of the items, unless a relevant context clearly indicates otherwise.

In the present disclosure, an expression “A or B,” “at least one of A and B,” “at least one of A or B,” , “A, B, or C”, “at least one of A, B, and C”, “at least one of A, B, or C”, or the like, may include any one of the items enumerated together or all possible combinations thereof.

A term “and/or” includes a combination of a plurality of related items or any one of the plurality of related items.

Terms such as “first”, “second”, or the like may be used simply to distinguish one element and another element from each other, and do not limit the corresponding components in any other respect (e.g., importance or order).

In addition, terms such as “front end,” “rear end,” “upper surface,” “lower surface,” “side surface,” “left side,” “right side,” “upper part,” “lower part,” “region,” and the like, used in the present disclosure are defined based on the drawings. The shapes and positions of respective components are not limited to these terms.

It should be further understood that terms “include”, “have” or the like, used in the specification specify the presence of features, numerals, steps, operations, components, parts mentioned in the specification or combinations thereof, and do not preclude the presence or addition of one or more other features, numerals, steps, operations, components, parts, or combinations thereof.

When a component is referred to as being “connected,” “coupled,” “supported,” or “in contact” with another component, it includes not only a case where the components are directly connected, coupled, supported, or in contact with each other, but also a case where the components are indirectly connected, coupled, supported, or in contact with each other through a third component.

In case that a component is referred to be disposed “on” another component, it includes not only a case where the component is in contact with another component, but also a case where still another component exists between the two components.

In addition, as used throughout the specification, a term of degree “about”, “substantially”, or the like is used to indicate the number of a stated meaning or its approximation when its manufacturing or material tolerance inherent therein are given. Such a term is used to prevent unscrupulous infringers from unfairly using the present disclosure in which exact or absolute figures are stated to facilitate the understanding of this application.

A term “stream” used herein may refer to a flow of fluid in a process, and may refer to the fluid itself flowing in the pipe. In detail, the stream may refer to both the fluid itself and the flow of the fluid flowing in the pipe connecting devices to each other. In addition, the fluid may include one or more components among gas, liquid, and solid.

A term “an upper part” used herein may refer to a point at a height of 0% to 20% from the top of the device, unless otherwise specified, and may specifically refer to the top (or the uppermost part). In addition, a term “a lower part” may refer to a point at a height of 80% to 100% from the top of the device, and may specifically refer to the bottom (or the lowermost part).

Hereinafter, specific aspects of the present disclosure are described in detail with reference to the drawings.

Further, in describing the aspects of the present disclosure, omitted is a detailed description of a case where it is decided that the detailed description of the known function or configuration related to the present disclosure may unnecessarily obscure the gist of the present disclosure.

According to the present disclosure, provided are a method for cleaning a reactor and a system for cleaning a reactor.

The method for cleaning a reactor according to an aspect of the present disclosure may include: partially filling a reactor 100 with a cleaning solvent CS by supplying the cleaning solvent CS from a cleaning solvent supply unit 200 to the reactor 100 through a cleaning solvent supply line L13; heating the cleaning solvent CS in the reactor 100; and filling the reactor 100 with the cleaning solvent CS by additionally supplying the cleaning solvent CS from the cleaning solvent supply unit 200 to the reactor 100 through the cleaning solvent supply line L13, and transporting a cleaning solvent stream including polymers to the cleaning solvent supply unit 200 through a cleaning solvent discharge line L14 connected to an upper part of the reactor 100.

In addition, in the heating of the cleaning solvent CS in the reactor 100, a lower discharge stream of the reactor 100 may be supplied to one or more heating devices 110, 120, and 130, and refluxed to a side of the reactor 100.

In an aspect, in the heating of the cleaning solvent CS in the reactor 100, a first lower discharge stream of the reactor 100 may be supplied to the first heating device 110, and then refluxed to a first reflux inlet located on one side of the reactor 100, and a second lower discharge stream of the reactor 100 may be supplied to the second heating device 120, and then refluxed to a second reflux inlet located on the other side of the reactor 100. The system for cleaning a reactor according to an aspect of the present disclosure may include: the cleaning solvent supply unit 200 receiving, storing, and preheating the cleaning solvent CS supplied from the outside, supplying the cleaning solvent CS by being connected to one or more of the lower part or side of the reactor 100 through the cleaning solvent supply line L13, and recovering the cleaning solvent CS discharged from the reactor by being connected to the upper part of the reactor 100 through the cleaning solvent discharge line L14; the first heating device 110 heating the cleaning solvent CS in the reactor using a steam as a heat source by being connected to one side of the reactor 100 through a first heating circulation line L21; and the second heating device 120 heating the cleaning solvent CS in the reactor using the steam as the heat source by being connected to the other side of the reactor 100 through a second heating circulation line L22.

In addition, the first heating device 110 may be 1.5 to 2 times longer than the second heating device 120, and the reflux inlet of the first heating device 110 may have a height lower than the second heating device 120.

In addition, an auxiliary circulation line L12 may connect the cleaning solvent supply line L13 and the cleaning solvent discharge line L14 to each other, and the auxiliary circulation line may have one side connected between a valve 302 disposed on the cleaning solvent supply line and the cleaning solvent supply unit 200, and the other side connected between a valve 303 disposed on the cleaning solvent discharge line and the cleaning solvent supply unit 200.

According to an aspect of the present disclosure, the reactor 100 may be a reactor for oligomerization of ethylene. In detail, alpha-olefin is widely used commercially as an important material used in a comonomer, a detergent, a lubricant, a plasticizer, or the like. In particular, 1-hexene and 1-octene are widely used as the comonomers to control the density of polyethylene when producing linear low density polyethylene (LLDPE). Alpha-olefin may be produced through an oligomerization reaction of ethylene.

The oligomerization reaction of ethylene may be performed by the trimerization reaction or tetramerization reaction of ethylene in the presence of a catalyst using ethylene as a reactant. The oligomerization reaction may refer to a reaction in which monomers are polymerized. The oligomerization reaction may be referred to as trimerization and tetramerization, and collectively referred to as multimerization based on the number of monomers to be polymerized.

The catalyst used in the oligomerization reaction of ethylene may include a transition metal source. The transition metal source may be, for example, a compound including at least one selected from the group consisting of chromium (III) acetylacetonate, chromium (III) chloride tetrahydrofuran, chromium (III) 2-ethylhexanoate, chromium (III) tris (2,2,6,6-tetramethyl-3, 5-heptanedionate), chromium (III) benzoylacetonate, chromium (III) hexafluoro-2, 4-pentanedionate, chromium (III) acetate hydroxide, chromium (III) acetate, chromium (III) butyrate, chromium (III) pentanoate, chromium (III) laurate, and chromium (III) stearate.

For example, a cocatalyst may include at least one selected from the group consisting of trimethyl aluminum, triethylaluminum, triisopropylaluminum, triisobutylaluminum, ethylaluminum sesquichloride, diethylaluminum chloride, ethyl aluminum dichloride, methylaluminoxane, modified methylaluminoxane and borate.

In this way, in a process of oligomerizing ethylene monomer in the presence of the catalyst, the polymer such as polyethylene may be produced as a by-product during the catalytic reaction in addition to an oligomer product. The polymer may float in a liquid reaction medium within the reactor, and be accumulated on an inner wall of the reactor or the like over time, thus causing a fouling phenomenon in which polymers P are accumulated to a certain thickness. In this case, it is necessary to shut down an operation of the reactor and clean the reactor and reactor additional equipment.

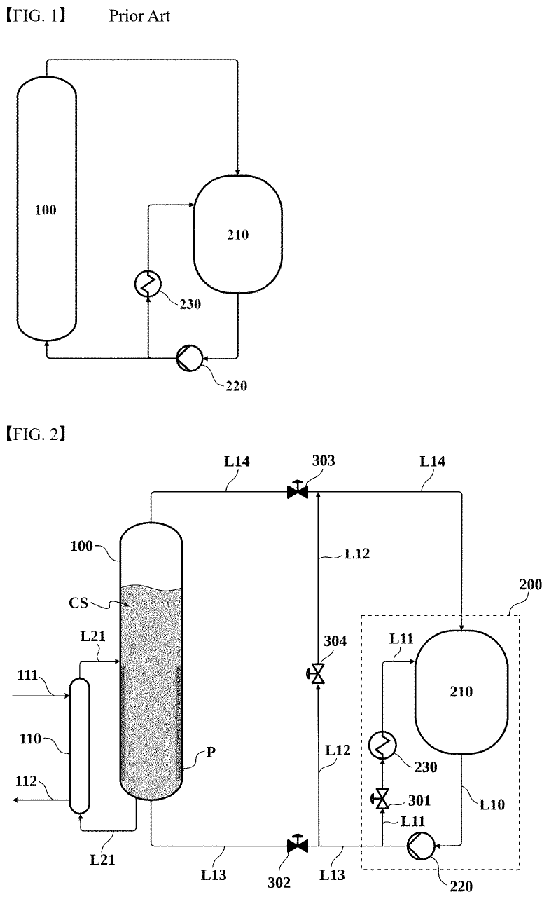

Conventionally, as shown in FIG. 1, in order to clean the reactor 100 fouled by the polymer, used is a method of injecting a high-temperature solvent preheated to a high temperature using a heater 230 from a cleaning solvent reservoir 210 into the reactor 100 by a pump 220, and then circulating the solvent. In this case, at the beginning of a cleaning process of the reactor 100, the polymer may be molten in the high-temperature cleaning solvent. Here, during a transportation process of the cleaning solvent in which the polymer is molten after cleaning the reactor, a temperature of the solvent in a transportation pipe may be reduced due to external heat loss. Further, due to the heat loss occurring during the transportation process, the polymer molten in the cleaning solvent may have improved adhesion, which may lead to a plugging phenomenon occurring in the transportation pipe, the valve, or the like.

In this regard, the present disclosure may provide the method for cleaning a reactor that circulates the cleaning solvent while maintaining a high temperature between the cleaning solvent supply unit 200 storing the cleaning solvent and the reactor 100 to effectively clean the reactor and its surrounding device fouled by the polymer, and simultaneously clean the reactor in a short period of time by improving a cleaning rate based on the optimized operating condition and cleaning method. In addition, when cleaning the reactor using the method according to the present disclosure, it is possible to reduce a cleaning operation time to thus increase an annual plant operation rate, thereby securing improved production. Furthermore, the method according to the present disclosure may reduce cleaning costs, improve reaction stability by shortening a reaction normalization time after the cleaning, and prevent the plugging from occurring in the pipe by maintaining the temperature of the cleaning solvent to a certain level or above.

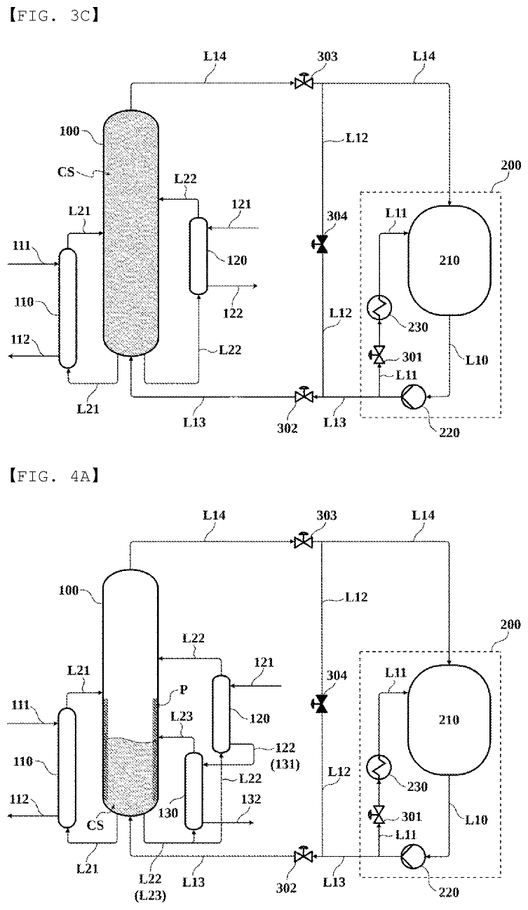

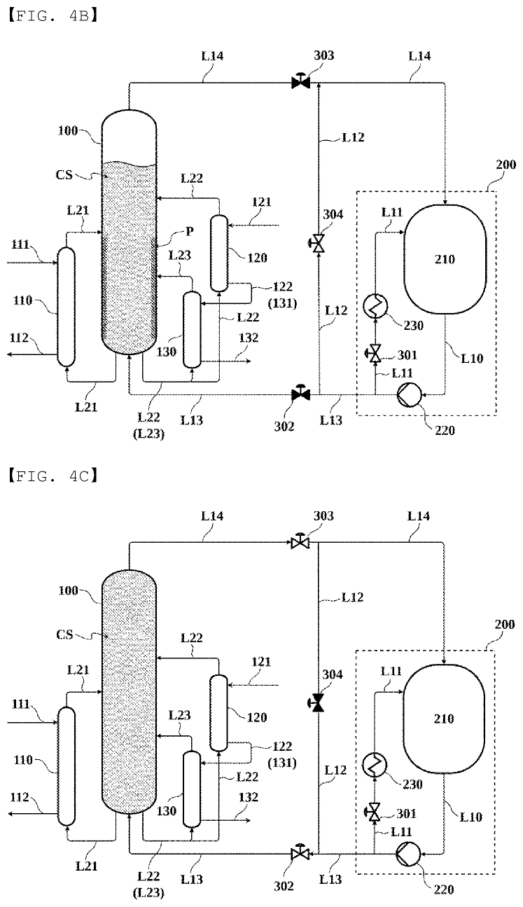

As shown in FIGS. 3A and 4A, in the method for cleaning a reactor according to an aspect of the present disclosure, the cleaning solvent CS may be supplied from the cleaning solvent supply unit 200 to the reactor 100 through the cleaning solvent supply line L13 to partially fill the reactor 100 in order to inject the cleaning solvent CS into the reactor immediately after the reaction is completed.

According to an aspect of the present disclosure, the cleaning solvent CS may be used to clean the reactor 100. For example, the cleaning solvent CS may include at least one selected from the group consisting of n-pentane, n-hexane, n-heptane, n-decane, cyclohexane, methyl cyclohexane, benzene, xylene, toluene, ethylbenzene, chlorobenzene, dichlorobenzene, and trichlorobenzene. As a specific example, the cleaning solvent CS may be methyl cyclohexane, toluene, or n-decane.

The cleaning solvent supply unit 200 may include the cleaning solvent reservoir 210, and further include the pump 220 and the heater 230, if necessary.

According to an aspect of the present disclosure, the cleaning solvent CS may be injected into the cleaning solvent reservoir 210 of the cleaning solvent supply unit 200, and may be preheated by operating the pump 220 and the heater 230. In detail, the cleaning solvent CS supplied to the cleaning solvent reservoir 210 may be discharged through a lower discharge line L10 of the cleaning solvent reservoir, and preheated while being circulated through a preheating circulation line L11 branched from the lower discharge line L10 of the cleaning solvent reservoir and connected to the cleaning solvent reservoir 210. For example, it is possible to maintain the temperature of the cleaning solvent CS while simultaneously increasing a temperature of the transportation pipe by discharging a cleaning solvent stream through the preheating circulation line L11, circulating the cleaning solvent stream to the cleaning solvent reservoir 210 using the pump 220, and preheating the cleaning solvent CS to a desired temperature by using the heater 230 disposed on the preheating circulation line L11.

A first valve 301 may be disposed on the preheating circulation line L11. The first valve 301 may be fully opened when preheating the cleaning solvent stream, and throttled to adjust a flow rate when supplying the cleaning solvent stream to the cleaning solvent supply line L13.

The temperature of the cleaning solvent stream preheated while circulated in the preheating circulation line L11 may be, for example, 140° C. or more, 145° C. or more, or 150° C. or more, 160° C. or less, 165° C. or less, or 170° C. or less. When cleaning the reactor 100 after preheating the cleaning solvent CS within the above range, the fouling polymer P may be sufficiently swollen and easily removed through the circulation of the cleaning solvent CS.

According to an aspect of the present disclosure, the cleaning solvent supply line L13 may be connected to the lower part of the reactor 100 to supply the cleaning solvent, and the cleaning solvent discharge line L14 may be connected to the upper part of the reactor 100 to discharge the cleaning solvent. In addition, the cleaning solvent supply line L13 and the cleaning solvent discharge line L14 may be connected to the cleaning solvent supply unit 200. Through this structure, the cleaning solvent CS may be circulated between the reactor 100 and the cleaning solvent supply unit 200.

According to an aspect of the present disclosure, the cleaning solvent stream may be supplied from the cleaning solvent supply unit 200 to one or more of the lower part and side of the reactor 100 to partially fill the reactor 100. In detail, the cleaning solvent stream discharged to the lower discharge line L10 of the cleaning solvent reservoir may be supplied to the reactor 100 through the cleaning solvent supply line L13.

The lower discharge line L10 of the cleaning solvent reservoir that is connected to the lower part of the cleaning solvent reservoir 210 may be branched into the preheating circulation line L11 and the cleaning solvent supply line L13, described above, and the cleaning solvent stream may be supplied to the reactor 100 through the cleaning solvent supply line L13. Here, the cleaning solvent supply line L13 may indicate a line connected from the lower discharge line L10 of the cleaning solvent reservoir to the reactor 100.

The second valve 302 may be disposed on the cleaning solvent supply line L13 adjacent to the lower discharge line L10 of the cleaning solvent reservoir, and the third valve 303 may be disposed on the cleaning solvent discharge line L14. The second valve 302 and the third valve 303 may be closed to preheat the cleaning solvent stream or isolate the reactor 100 when heating the cleaning solvent in the reactor, which is to be described below, and may be opened when supplying the cleaning solvent CS to the reactor 100 or circulating the cleaning solvent stream.

The cleaning solvent stream discharged from the cleaning solvent supply unit 200 may be supplied to the lower part of the reactor 100, supplied to the side of the reactor 100, or simultaneously supplied to the lower part and the side. Here, the lower part of the reactor 100 may indicate the bottom of the reactor 100. When the bottom of the reactor 100 is 0% and the top of the reactor 100 is 100%, the side of the reactor 100 may indicate 5% or more, 6% or more, 7% or more, and 18% or less, 19% or less, or 20% or less of a total height of the reactor 100. When supplying the cleaning solvent CS to the side of the reactor 100 within the above range, it is possible to improve power of cleaning the polymers P accumulated on the wall of the reactor 100 and its additional equipment such as a sensor.

In detail, it is possible to smoothly clean the reactor 100 even when supplying the cleaning solvent stream discharged from the cleaning solvent supply unit 200 to the lower part and the side of the reactor 100, respectively. When supplying the cleaning solvent stream simultaneously to the lower part and the side of the reactor 100, a flow direction of the cleaning solvent CS in the reactor 100 may be continuously changed, thus making it possible to improve the power of cleaning the polymers P accumulated in the lower part and wall of the reactor 100, as well as its additional equipment such as the sensor installed in the reactor 100.

Here, as shown in FIGS. 3B and 4B, the cleaning solvent CS partially filling the reactor may fill the reactor to the certain level or above to sufficiently immerse a portion where the polymer fouling is expected. For example, the cleaning solvent CS may fill about 50 vol % or more, 55 vol % or more, and 65 vol % or less, or 70 vol % or less of the reactor 100. When the cleaning solvent fills the reactor within the above range, it is possible to sufficiently immerse the fouling polymer P in the cleaning solvent CS, and also improve cleaning efficiency by melting the polymer P using the cleaning solvent which is heated in a subsequent process. In detail, during an operation of the reactor, the polymers may be mainly accumulated and fouling on the inner wall of an inner region of the reactor, which is maintained for a residence time of the reactant such as the monomer. Therefore, it is possible to shorten a heating time while increasing a polymer removal efficiency by filling the reactor with the cleaning solvent CS for the fouling polymer on the inner wall of the reactor to be sufficiently immersed and then heat the same before circulating the cleaning solvent CS.

According to an aspect of the present disclosure, as shown in FIGS. 3B and 4B, the cleaning solvent CS partially filling the reactor 100 may be heated.

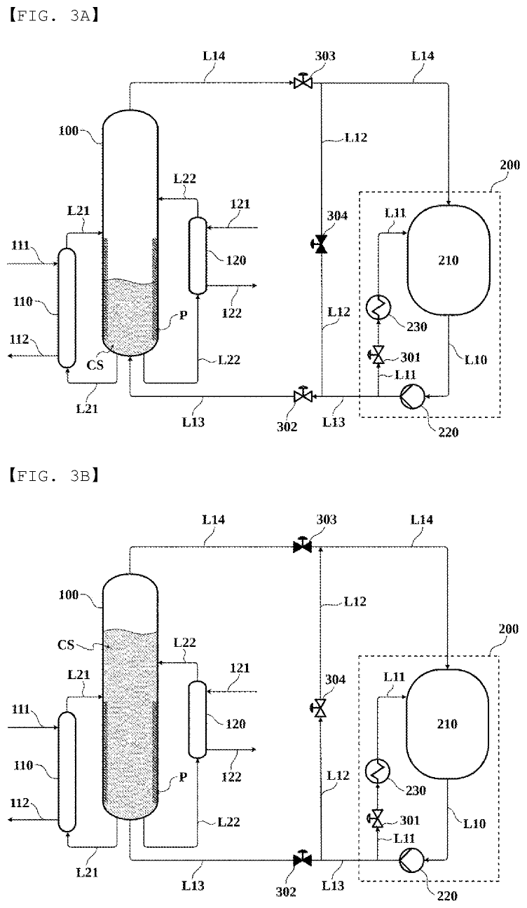

In detail, one or more heating devices for heating the cleaning solvent CS in the reactor may be disposed outside the reactor 100. For example, one or more heating devices may include one heating device 110 as shown in FIG. 2, include the first heating device 110 and the second heating device 120 as shown in FIGS. 3A to 3C, or further include a third heating device 130 as shown in FIGS. 4A to 4C, if necessary.

As described above, the cleaning solvent stream may be supplied to the reactor to partially fill the same, and the second valve 302 and the third valve 303 may be closed to isolate the reactor. In this state, thermosiphon hot flushing may be performed for a certain period of time by operating one or more heating devices disposed outside the reactor. Here, one or more heating devices designed in different sizes may be operated simultaneously. As a result, the thermosiphon mixing effect may be expected to quickly raise the temperature of the cleaning solvent filling the reactor and simultaneously melt the fouling polymer P in the short period of time. In addition, the cleaning solvent CS may secure a sufficient temperature to melt the fouling polymer P through one or more heating devices disposed outside the reactor even when the temperature of the cleaning solvent CS preheated by the cleaning solvent supply unit 200 is reduced due to the heat loss occurring in the process that the cleaning solvent CS is transported to the reactor 100.

The reactor 100 may be heated to have an internal temperature heated from a reaction temperature immediately after the reaction is completed to a cleaning temperature at which the polymer melting is possible. For example, through a heating process performed using one or more heating devices, the internal temperature of the reactor 100, that is, the temperature of the cleaning solvent in the reactor, may be increased to 140° C. or more, 145° C. or more, and 155° C. or less, or 160° C. or less, and then maintain this temperature range. The internal temperature of the reactor may satisfy the above temperature range in the cleaning process to thus melt the polymer P fouling on the inner wall of the reactor, or the like, thereby making efficient cleaning possible.

In addition, the cleaning solvent may partially fill the reactor and then be heated immediately after the reaction is completed, thus shortening a preparation time for the cleaning, that is, the heating time. For example, a time for preheating the inside of the reactor may be 1 hour or less.

According to an aspect of the present disclosure, as shown in FIG. 2, the lower discharge stream of the reactor 100 may be supplied to the heating device 110 and then refluxed to the reflux inlet located on one side of the reactor 100. The heating device 110 may be a double pipe heat exchanger. For example, heat exchange may be performed by supplying the steam to a heat source 111 of the heating device, and a condensate 112 of the heating device may then be discharged.

According to an aspect of the present disclosure, as shown in FIGS. 3A to 3C, the first lower discharge stream of the reactor 100 may be supplied to the first heating device 110, and then be refluxed to the first reflux inlet located on one side of the reactor 100; and the second lower discharge stream of the reactor 100 may be supplied to the second heating device 120, and then be refluxed to the second reflux inlet located on the other side of the reactor 100. The first and second heating devices 110 and 120 may each independently be the double pipe heat exchanger. For example, the steam may be supplied to the heat source 111 of the first heating device to thus perform the heat exchange, thereby discharging the condensate 112 of the first heating device; and the steam may be supplied to a heat source 121 of the second heating device to thus perform the heat exchange, thereby discharging a condensate 122 of the second heating device.

For example, when one or more heating devices are provided as two or more heating devices, the first heating device 110 may have the largest size for the cleaning solvent stream that passed through the first heating circulation line L21 to form a fast flow rate. For example, the first heating device 110 may be longer than the second heating device 120 by 1.5 times or more, 1.6 times or more, or 1.7 times or more, and 1.8 times or less, 1. 9 times or less, or 2 times or less. Here, a length (height) of the heating device indicates its length (height) from one side of the heating device where the cleaning solvent flows in to the other side of the heating device where the cleaning solvent is discharged. Referring to FIGS. 3B and 4B, the first heating device 110, which has the longest length among two or more heating devices, may reflux the cleaning solvent CS through the first reflux inlet located on one side of the reactor 100, thus providing a high flow rate of the cleaning solvent in the reactor.

For example, when one or more heating devices are provided as two or more heating devices, the reflux inlets, through which the cleaning solvent stream is refluxed from two or more heating devices, may have different heights. In detail, the second reflux inlet of the second heating device 120 may be located to be higher than the first reflux inlet of the first heating device 110. The second reflux inlet may be located to be higher than the first reflux inlet to thus form a large amount of circulation flow using a high head pressure of the cleaning solvent that is refluxed from the second reflux inlet to the reactor, which may form a large swirl in the reactor.

Meanwhile, in the system for cleaning a reactor according to an aspect of the present disclosure, in addition to the second heating device 120, the third heating device 130 connected to a third heating circulation line L23 may be disposed on the other side of the reactor.

According to an aspect of the present disclosure, as shown in FIGS. 4A to 4C, a portion of the second lower discharge stream of the reactor 100 may be branched and supplied to the second heating device 120, and then refluxed to the second reflux inlet located on the other side of the reactor 100, and the remaining stream may be supplied to the third heating device 130 and then refluxed to the third reflux inlet located on the other side of the reactor 100. The third heating device 130 may be the double pipe heat exchanger. For example, the steam may be supplied to the heat source 121 of the second heating device to thus perform the heat exchange, thereby discharging the condensate 122 of the second heating device, which may be used as a heat source 131 of the third heating device to thus perform the heat exchange, thereby discharging a condensate 132 of the third heating device.

In detail, the second heating device 120 may provide a large flow of the cleaning solvent in the reactor by using a latent heat of the steam as the heat source, and the third heating device 130 may provide a smaller flow of the cleaning solvent in the reactor by using the condensate, in which the steam is mostly condensed, as the heat source. In this way, vertical and horizontal mixing flows may be formed in the reactor, which may implement internal behavior that may more efficiently and quickly melt the fouling polymer P in the reactor.

In addition, when the third heating device 130 is further provided, the third reflux inlet may be lower than the second reflux inlet, and the first reflux inlet may have a height between those of the second reflux inlet and the third reflux inlet.

For example, when the bottom of the reactor 100 is 0% and the top of the reactor 100 is 100%, the first reflux inlet may have a height of 20% or more, 22% or more, 24% or more, and 26% or less, 28% or less, or 30% or less of the total height of the reactor 100; the second reflux inlet may have a height of 50% or more, 52% or more, 54% or more, or 56% or more, and 64% or less, 66% or less, 68% or less, or 70% or less of the total height of the reactor 100; and the third reflux inlet may have a height of 10% or more, 12% or more, or 14% or more, and 16% or less, 18% or less, or 20% or less of the total height of the reactor 100.

When one or more heating devices are provided as two or more heating devices, the second heating device 120, where the reflux inlet is highest among the plurality of heating devices, may form a large swirl in the cleaning solvent CS in the reactor by a large amount of circulation flow using a high water pressure of the cleaning solvent stream that passed through the second heating circulation line L22. Further, when the third heating device 130 is further provided, the high-temperature condensate used in the second heating device 120 may be injected as the heat source of the third heating device 130 to thus perform the heat exchange, and the cleaning solvent stream that passed through the third heating circulation line L23 may form a small swirl as the stream is refluxed through the third reflux inlet. In this way, the cleaning solvent in the reactor may be vertically and horizontally mixed by the reflux inlets of the plurality of heating devices respectively having the different heights, thereby further improving the cleaning power against the fouling polymer P.

Meanwhile, the cleaning solvent CS preheated by the cleaning solvent supply unit 200 may be circulated through the auxiliary circulation line L12 connecting the cleaning solvent supply line L13 and the cleaning solvent discharge line L14 to each other while heating the cleaning solvent CS in the reactor 100. In more detail, the auxiliary circulation line L12 may have one side connected between the second valve 302 of the cleaning solvent supply line L13 and the cleaning solvent supply unit 200, and the other side connected between the third valve 303 of the cleaning solvent discharge line L14 and the cleaning solvent supply unit 200.

In addition, a fourth valve 304 may be disposed on the auxiliary circulation line L12. In detail, as shown in FIGS. 3A, 3C, 4A and 4C, the fourth valve 304 may be closed when the second and third valves 302 and 303 are opened, and as shown in FIGS. 3B and 4B, the fourth valve 304 may be opened when the second and third valves 302 and 303 are closed. In this way, while the second and third valves 302 and 303 are closed to isolate the reactor and heat the cleaning solvent CS in the reactor, the valves 301 and 304 of the preheating circulation line L11 and the auxiliary circulation line L12 may be opened to thus operate both the circulation lines simultaneously. In this case, a rear stage pipe through which the cleaning solvent stream that is discharged from the reactor is transported, that is, the cleaning solvent discharge line L14, may be sufficiently warmed during a corresponding time. As a result, it is possible to prevent the plugging from occurring when the cleaning solvent CS, in which the polymer P is molten, passes through the cleaning solvent discharge line L14.

According to an aspect of the present disclosure, as shown in FIGS. 3C and 4C, the cleaning solvent CS may be additionally supplied from the cleaning solvent supply unit 200 to the reactor 100 through the cleaning solvent supply line L13 to fill the reactor 100, and the cleaning solvent stream including the polymer may be transported to the cleaning solvent supply unit 200 through the cleaning solvent discharge line L14 connected to the upper part of the reactor 100.

In detail, the reactor 100 may be filled with the cleaning solvent CS, and the cleaning solvent stream may then be continuously supplied to the reactor 100 to thus circulate the high-temperature cleaning solvent stream between the cleaning solvent supply unit 200 and the reactor 100. Here, the plurality of heating devices disposed outside the reactor may be continuously operated, and the internal temperature of the reactor 100 may be maintained at 140° C. or more or 145° C. or more, and 155° C. or less or 160° C. or less. When circulating the cleaning solvent stream, the internal temperature of the reactor 100 may be controlled to the above range. As a result, the polymers P accumulated on the inner wall of the reactor 100 may be removed by being molten in the cleaning solvent. Further, it is possible to prevent turbulence and heat loss in the reactor by operating the plurality of heating devices, thereby more effectively removing the fouling polymer from the inner wall of the reactor.

In addition, the temperature of the cleaning solvent stream discharged to the upper part of the reactor 100 may be 140° C. or more, 145° C. or more, and 155° C. or less or 160° C. or less. The fouling polymer P may be molten in the cleaning solvent stream discharged to the upper part of the reactor 100. Therefore, it is necessary to maintain the temperature of the cleaning solvent stream to be sufficiently high when the cleaning solvent stream is discharged and circulated in order to prevent the plugging occurring from the cleaning solvent discharge line L14. Therefore, as the cleaning solvent stream satisfies the above temperature range, it is possible to prevent the pipe plugging by the polymer P when the cleaning solvent stream is circulated.

The time for the cleaning solvent stream to be discharged from the reactor 100 and circulated may be 12 hours or more, 14 hours or more, or 16 hours or more, and 20 hours or less, 22 hours or less, or 24 hours or less. In addition, the flow rate at which the cleaning solvent stream is discharged from the reactor 100 and circulated may be 100 kg/hr or more, 150 kg/hr or more, or 200 kg/hr or more, and 300 kg/hr or less, 400 kg/hr or less, or 500 kg/hr or less. It is possible to improve the cleaning rate of the polymers P accumulated in the reactor satisfying the above conditions when the cleaning solvent stream is circulated.

Cleaning the reactor using the method according to the present disclosure may clearly eliminate a possibility of the plugging the cleaning solvent in the transportation pipe that may occur in the cleaning process, and completely remove the fouling polymer P in the reactor in the short period of time with the cleaning efficiency significantly higher than that of the conventional cleaning method. Ultimately, the cleaning method according to the present disclosure may also secure improved economic efficiency as the method may enable a normal process operation of the reactor after its quick cleaning.

Hereinabove, the method and system for cleaning a reactor according to the present disclosure are described and shown in the drawings. However, the descriptions and drawings provided above describe and show only the core components for understanding the present disclosure. In addition to the processes and devices described and shown in the description and drawings provided above, processes and devices not separately described or shown may be appropriately applied and used to perform the method and system for cleaning a reactor according to the present disclosure.

In addition, those skilled in the art will understand that various changes and modifications may be made without departing from the concept and scope of the following claims.

### DESCRIPTION OF SYMBOLS

100: reactor
110, 120, 130: heating device
111, 121, 131: heat source of heating device
112, 122, 132: condensate of heating device
200: cleaning solvent supply unit, 210: cleaning solvent reservoir, 220: pump, 230: heater
301, 302, 303, 304: valve
L10: lower discharge line of cleaning solvent reservoir
L11: preheating circulation line, L12: auxiliary circulation line
L13: cleaning solvent supply line, L14: cleaning solvent discharge line
L21, L22, L23: heating circulation line
CS: cleaning solvent
P: fouling polymer

1. A method for cleaning a reactor, the method comprising:
partially filling the reactor with a cleaning solvent by passing the cleaning solvent from a cleaning solvent supply unit to the reactor through a cleaning solvent supply line;
heating the cleaning solvent in the reactor;
filling the reactor with the cleaning solvent by passing the cleaning solvent from the cleaning solvent supply unit to the reactor through the cleaning solvent supply line, and transporting a cleaning solvent stream including polymers to the cleaning solvent supply unit through a cleaning solvent discharge line connected to an upper part of the reactor,
wherein heating the cleaning solvent in the reactor comprises passing a lower discharge stream of the reactor to one or more heating devices, and to a side of the reactor.

2. The method of claim 1, wherein heating of the cleaning solvent in the reactor comprises:
passing a first lower discharge stream of the reactor to a first heating device, and then passing the first lower discharge stream to a first reflux inlet located on a first side of the reactor, and(
passing a second lower discharge stream of the reactor to a second heating device, and then passing the second lower discharge stream to a second reflux inlet located on a second side of the reactor.

3. The method of claim 2, wherein the first heating device is 1.5 to 2 times longer than the second heating device.

4. The method of claim 2, wherein heating the cleaning solvent in the reactor further includes passing a first portion of the second lower discharge stream of the reactor to the second heating device, and then refluxing the first portion of the second lower discharge stream to the second reflux inlet located on the second side of the reactor, and passing a second portion of the second lower discharge stream to a third heating device and then refluxing the second portion of the second lower discharge stream to a third reflux inlet located on the second side of the reactor.

5. The method of claim 1, wherein heating the cleaning solvent in the reactor comprises passing the lower discharge stream to two or more heating devices, and
wherein the cleaning solvent lower discharge stream is passed from each of the two or more heating devices to the side of the reactor at a different height on the side of the reactor.

6. The method of claim 4, wherein the first reflux inlet has a height between a height of the second reflux inlet and a height of the third reflux inlet, and
wherein the second reflux inlet is higher than the third reflux inlet.

7. The method of claim 1, further comprising preheating the cleaning solvent to a temperature from 140° C. to 170° C. in the cleaning solvent supply unit.

8. The method of claim 1, further comprising circulating the cleaning solvent, preheated in the cleaning solvent supply unit, through an auxiliary circulation line connecting the cleaning solvent supply line and a cleaning solvent discharge line to each other while heating the cleaning solvent in the reactor.

9. The method of claim 1, wherein the cleaning solvent is passed from the cleaning solvent supply unit to one or more of a lower part of the reactor and a side of the reactor.

10. The method of claim 1, wherein an internal temperature of the reactor is from 140° C. to 160° C.

11. The method of claim 1, wherein a temperature of the cleaning solvent stream discharged from the upper part of the reactor is from 140° C. to 160° C.

12. The method of claim 1, wherein the cleaning solvent comprises n-pentane, n-hexane, n-heptane, n-decane, cyclohexane, methyl cyclohexane, benzene, xylene, toluene, ethylbenzene, chlorobenzene, dichlorobenzene, or trichlorobenzene.

13. A system for cleaning a reactor, the system comprising:
a cleaning solvent supply unit configured to receive, store, and preheat a cleaning solvent supplied from the outside and configured to supply the cleaning solvent, wherein the cleaning solvent supply unit is connected to one or more of a lower part of the reactor or a side of the reactor through a cleaning solvent supply line, and wherein the cleaning solvent supply unit is configured to recover the cleaning solvent discharged from the reactor, wherein the cleaning solvent supply unit is connected to an upper part of the reactor through a cleaning solvent discharge line; and
a first heating device configured to heat the cleaning solvent in the reactor using a steam as a heat source, wherein the first heating device is connected to a first side of the reactor through a first heating circulation line,
wherein an auxiliary circulation line connects the discharge line to each other, and
the auxiliary circulation line has a first side connected between a valve disposed on the cleaning solvent supply line and the cleaning solvent supply unit, and a second side connected between a valve disposed on the cleaning solvent discharge line and the cleaning solvent supply unit.

14. The system of claim 13, further comprising a second heating device configured to heat the cleaning solvent in the reactor using a steam as a heat source, wherein the second heating device is connected to a second side of the reactor by a second heating circulation line,
wherein the first heating device is 1.5 to 2 times longer than the second heating device, and
wherein a reflux inlet of the first heating device has a height lower than a height of a reflux inlet of the second heating device.

15. The system of claim 14, further comprising a third heating device configured to heat the cleaning solvent in the reactor using a condensate as a heat source, wherein the condensate is condensed from the heat source of the second heating device, and wherein the third heating device is connected to a second side of the reactor by a third heating circulation line.
